(19) United States
(12) Patent Application Publication
(10) Pub. No.: US 2010/0268551 A1
(43) Pub. Date: Oct. 21, 2010

(54) SYSTEM FOR DATA MANAGEMENT, ANALYSIS, AND COLLABORATION OF MOVEMENT DISORDER DATA

(75) Inventors: JAMES MCNAMES, PORTLAND, OR (US); PEDRO MATEO RIOBO ABOY, BEAVERTON, OR (US); LARS HOLMSTROM, PORTLAND, OR (US); ANDREW GREENBERG, PORTLAND, OR (US)

Correspondence Address: ABOY&ASSOCIATES PC;www.aboypatentlaw.com, 522 SW 5th Ave, Suite 1265, Portland, OR, 97204, US

(73) Assignee: APDM, INC, Portland, OR (US)

(21) Appl. No.: 12/763,538

(22) Filed: Apr. 20, 2010

Related U.S. Application Data
(60) Provisional application No. 61/170,996, filed on Apr. 20, 2009.

(51) Int. Cl. G06Q 50/00; G06F 17/18; G06F 15/00

(52) U.S. Cl. 705/3; 702/141; 702/179

(57) ABSTRACT

Disclosed embodiments include a system for managing clinical data comprising: (a) a server configured to receive data from one or more external devices, and (b) a clinical data management application comprising one module for storing raw movement data received directly from at least one external device. The system is especially adapted for research in movement disorders and contains modules for investigators, collaborators, clinical subjects, and objective devices to upload movement disorders data, analyze data, obtain results of automatic analysis, publish results, and collaborate with other investigators.

### CROSS-REFERENCE TO RELATED APPLICATIONS

This application claims the benefit of U.S. Provisional Application No. 61/170,996 filed on 2009-04-20 by the present inventors, which is incorporated herein by reference.

### TECHNICAL FIELD

The technical field relates to data management systems. Specifically, it relates to clinical data management systems.

### BACKGROUND

Research, therapy development, and management of movement disorders requires the interaction and coordination of many distinct groups. The data collected during clinical trials and research studies in movement disorders such as Parkinson's disease and other pathologies often requires months to analyze. The raw data is rarely released to the public even after the study is completed and the results have been published. This makes it difficult to systematically compare the results of different studies or resolve differences in results.

Currently, there are only a handful of companies that produce devices that can be used for continuous or objective monitoring of movement disorders. None of these companies provides a web-based data management, analysis, and collaboration system designed to interface directly with movement disorder devices, including wearable movement monitors for continuous monitoring of movement disorders. Web-based data management systems exist for clinical trials, but these do not interface directly with the external objective monitoring devices and do not have the functionality required to support management, analysis, and collaboration involving data obtained from movement monitors, especially large amounts of objective movement data collected from sensors such as accelerometers, gyroscopes, and magnetometers embedded in such devices.

### SUMMARY

Disclosed embodiments include a system for managing clinical data comprising: (a) a server configured to receive data from one or more external devices, and (b) a clinical data management application comprising one module for storing raw movement data received from at least one external device.

### BRIEF DESCRIPTION OF THE DRAWINGS

Disclosed embodiments are illustrated by way of example, and not by way of limitation, in the figures of the accompanying drawings.

FIG. 1 illustrates a block diagram of one embodiment of a complete system for monitoring and management of movement disorders.

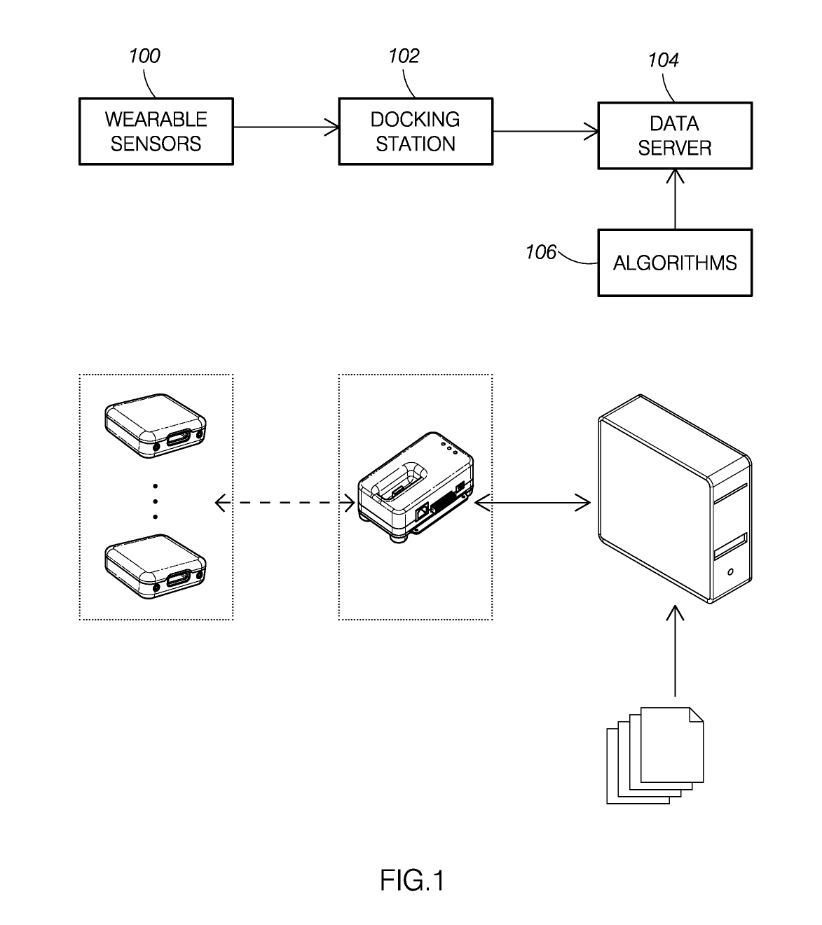

FIG. 2 illustrates a block diagram of one embodiment of a movement monitor.

FIG. 3 illustrates a block diagram of one embodiment of the clinical data management system.

FIG. 4 illustrates an embodiment of the GUI for uploading device data through the web based application.

FIG. 5 illustrates an embodiment of the GUI for adding collaborators to the current study.

FIG. 6 illustrates an embodiment of the GUI for creating a new study.

FIG. 7 illustrates an embodiment of the GUI of data management application.

FIG. 8 illustrates an embodiment of the GUI for the study overview application.

FIG. 9 illustrates an embodiment of the GUI for the subject enrollment application.

FIG. 10 illustrates an embodiment of the GUI for clinical rating scores.

### DETAILED DESCRIPTION

Certain specific details are set forth in the following description and figures to provide a thorough understanding of various embodiments disclosed. Certain well-known details often associated with computing and software technology are not set forth in the following disclosure to avoid unnecessarily obscuring the various disclosed embodiments. Further, those of ordinary skill in the relevant art will understand that they can practice other embodiments without one or more of the details described below. Aspects of the disclosed embodiments may be implemented in the general context of computer-executable instructions, such as program modules, being executed by a computer, computer server, or device containing a processor. Generally, program modules include routines, programs, objects, components, data structures, etc. that perform particular tasks or implement particular abstract data types. Aspects of the disclosed embodiments may also be practiced in distributed computing environments where tasks are performed by remote processing devices that are linked through a communications network. In a distributed computing environment, program modules may be located in both local and remote storage media including memory storage devices. Those skilled in the art will appreciate that, given the description of the modules comprising the disclosed embodiments provided in this specification, it is a routine matter to provide working systems which will work on a variety of known and commonly available technologies capable of incorporating the features described herein.

According to one embodiment, a complete system for movement disorder research and management comprises the following four components: one or more movement monitors 100, a docking station 102, a data server 104, and a plurality of computer-implemented analysis methods (algorithms) 106. Multiple movement monitors 100 send movement data to a docking station 102 which communicates with a data server 104. According to an alternative embodiment, the movement monitors 100 send movement data directly to the data server 104 for secure storage and management by a clinical data management system 309.

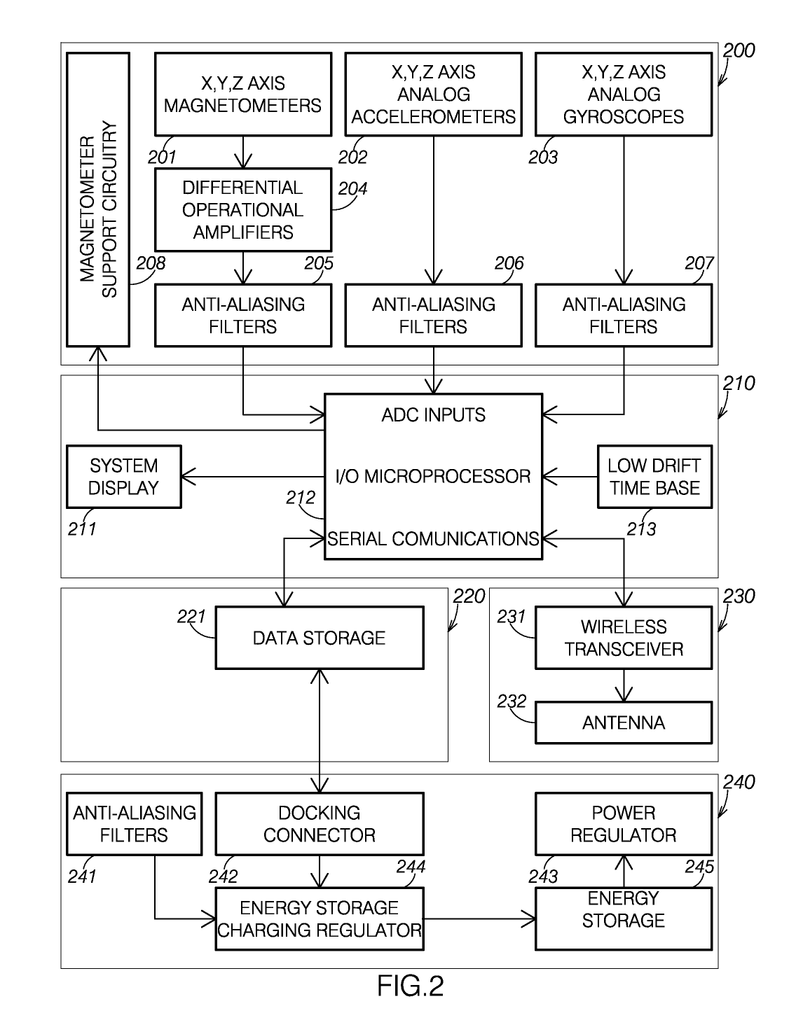

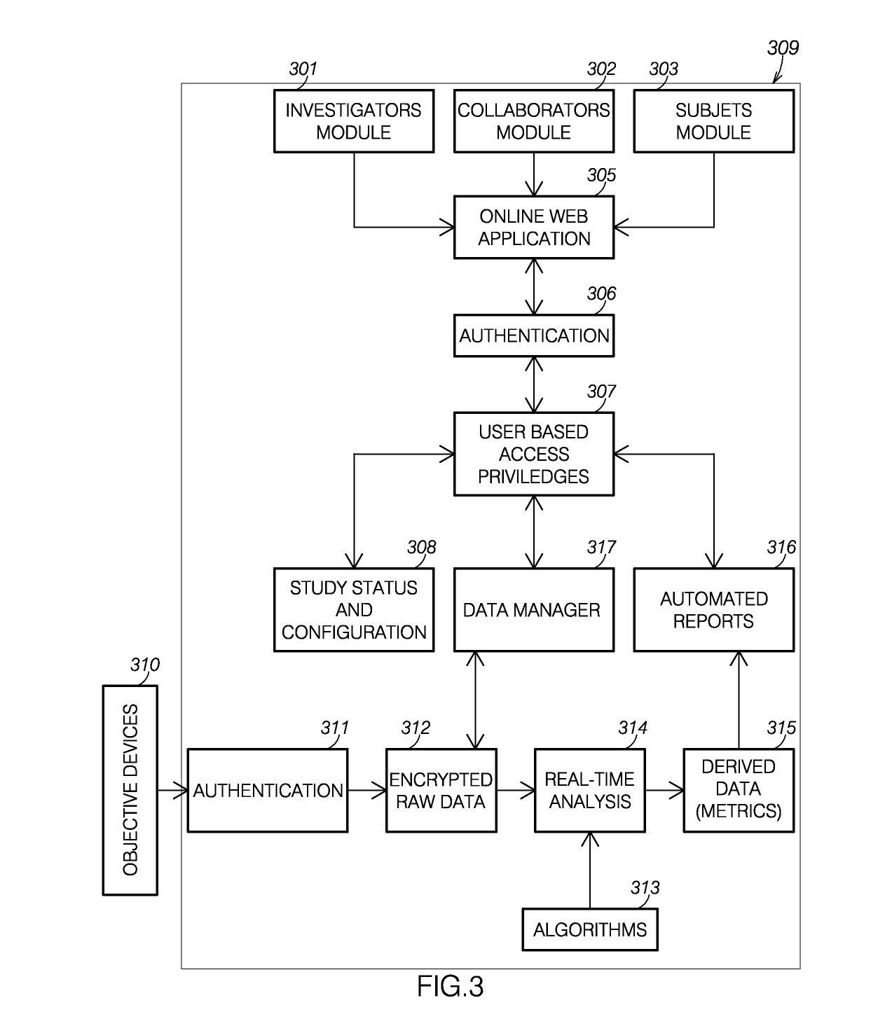

According to a particular embodiment, the system for managing clinical data comprises: (a) a server 104 configured to receive data from one or more external devices, and (b) a clinical data management application (system) 309 comprising one module for storing raw movement data received from at least one external device. In another embodiment, the clinical data management system 309 further includes a module to enable the raw movement data to be received directly from an external device such as a movement monitor capable of collecting accelerometer data, gyroscope data, and magnetometer data (FIG. 2). The clinical data management system 309 further includes a module for analyzing the raw movement data using a plurality of computer-implemented statistical analysis methods that comprise one or more digital signal processing and statistical signal processing techniques to process and analyze the raw data. The system includes a module for visualizing results and generating one or more automatic analysis reports and enable investigators, collaborators, and subjects to share data and obtain the automatic analysis reports based on a set of access privileges (FIG. 3-10).

Disclosed embodiments include systems for management, analysis, and collaboration of movement disorder data comprising computer implemented modules to enable 1) direct uploading of movement disorder data from objective devices such as wearable movement monitors or any other bioelectromechanical device that contains a transducer/sensor to objectively measure functional impairment due to a movement disorder, 2) automatic analysis of said movement disorder data using signal processing and statistical methods, 3) automatic report generation of analysis results, and 4) data sharing and research collaboration. As shown in FIG. 3 the system is especially adapted for research in movement disorders and contains modules for investigators, collaborators, clinical subjects, and objective devices to log-in, upload movement disorder data, analyze data, obtain results of automatic analysis, publish results, and collaborate with other investigators.

According to one embodiment, the clinical data management system 309 permits easy and secure uploading of movement disorders data from multiple sources (including direct upload from wearable movement monitors and objective movement disorder devices), and includes a module to generate analysis reports of these data performed automatically using digital signal processing methods after each upload. The design of the clinical data management system 309 is scalable to account for multiple users, studies, and a wide range of data types ranging from self-reported scores to multichannel signal data, speech, and video. The clinical data management system 309 supports both prospective studies and exploratory data analysis.

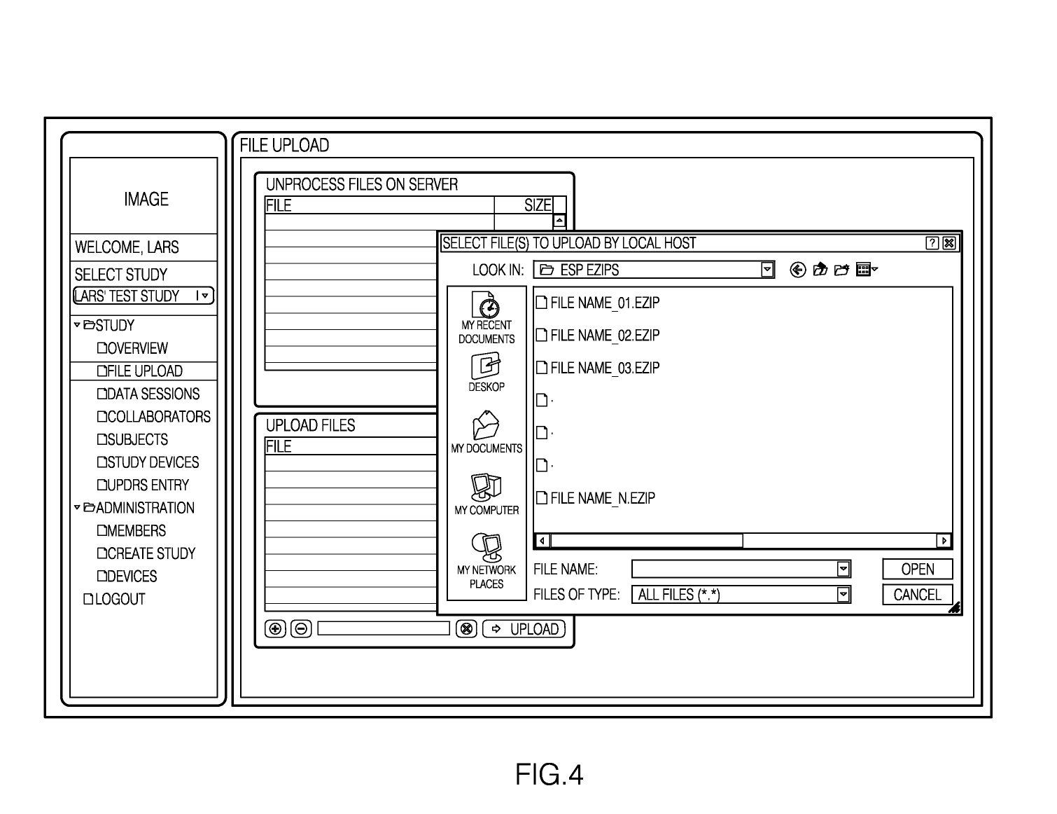

The clinical data management system 309 is designed to promote collaboration and accelerate the analysis of movement disorders data and dissemination of new knowledge. It includes a module to enable interactive advanced web graphics, wide support for report formats, and support for algorithm uploads and application to the stored data (FIG. 4-10).

### A. Objective Devices & Wearable Devices (Movement Monitors).

According to one embodiment and without limitation, objective devices are wearable devices (i.e. movement monitors) 100 that continuously record data from embedded sensors. The sensors 100 are designed to be worn at any convenient location on the body that can monitor impaired movement. Convenient locations include the wrists, ankles, and waist. In one to one embodiment, the sensors include one or more channels of electromyography, accelerometers, gyroscopes, magnetometers, or other small sensors that can be used to monitor movement. The wearable sensors 100 have sufficient memory and battery life to continuously record inertial data throughout the day from the moment subjects wake up until they go to sleep at night, typically 18 hours or more. The sensors 100 automatically start recording when they are removed from the docking station. In one embodiment, there is no need for the user to turn them on or off.

According to one embodiment, in order to facilitate use in the home and other normal daily environments, the device includes a docking station 102 that is used to charge the batteries of the wearable devices 100 and download the data from each day of activities. The docking station 102 uploads the data using whatever means is available in that setting. If highspeed internet access is available within the home, this may be used for data upload. Alternatively it permits the user to download the data to a portable storage device such as a USB thumb drive or hard drive that can then be transported to a site for final upload to the data server 104. If there is no simple means to download the data from the docking station 102, the data is downloaded once the docking station is returned at the end of the monitoring period. The docking station 102 requires no user intervention. The devices 100 stop recording as soon as they are docked and start recording as soon as they are undocked. According to one embodiment, the docking station 102 does not include any buttons. The docking station 102 can be connected to a computer for data extraction and processing, but this is optional. Convenient locations for wearable sensors also include thighs, upper arms, chest, and lower back.

According to one embodiment, objective devices or wearable devices 100 include the components and interconnections detailed in FIG. 2: a sensor block 200, a microprocessor block 210, a data storage block 221, a wireless communication block 230, and a power regulator 243. The sensor block 200 in FIG. 2 contains the motion sensors necessary to characterize the symptoms of movement disorders. Three of these sensors are low noise accelerometers 202. According to one embodiment, the accelerometers are off-the-shelf, commercially available Micro-ElectroMechanical Systems (MEMS) acceleration sensors in small surface-mount packages, such as the STMicro LIS344AHL. The accelerometers are arranged in three orthogonal axes either on a single multi-axis device, or by using one or more separate sensors in different mounting configurations. According to one embodiment, the output of the accelerometers 202 is an analog signal. This analog signal needs to be filtered to remove high frequency components by anti-aliasing filters 206, and then sampled by the analog-to-digital (ADC) peripheral inputs of the microprocessor 212. According to one embodiment the anti-aliasing filters are single pole RC low-pass filters that require a high sampling frequency; in another, they are operational amplifiers with multiple-pole low pass filters that may use a slower sampling frequency. According to another embodiment, the output of the accelerometers is digital, in which case the sensor must be configured for the correct gain and bandwidth and sampled at the appropriate rate to by the microprocessor 212. The next three sensors in the sensor block 200 are solid state, low noise rate gyroscopes 203. In one embodiment, the gyroscopes are off-the-shelf, commercially available Micro-ElectroMechanical Systems (MEMS) rotational sensors in small surface-mount packages, such as a the Invensense IDG-650 and the Epson Toyocomm XV-3500CBY. The gyroscopes are arranged in three orthogonal axes either on a single multi-axis device, or by using one or more separate sensors in different mounting configurations. According to one embodiment, the output of the gyroscopes 203 is an analog signal. This analog signal needs to be filtered to remove high frequency components by anti-aliasing filters 207, and then sample by the analog-to-digital (ADC) peripheral inputs of the microprocessor 212. According to one embodiment the anti-aliasing filters are single pole RC low-pass filters that require a high sampling frequency; in another, they are operational amplifiers with multiple-pole low pass filters that may use a slower sampling frequency. According to another embodiment, the output of the gyroscopes is digital, in which case the sensor must be configured for the correct gain and bandwidth and sampled at the appropriate rate by the microprocessor 212. The sensor block 200 also contains one or more aiding sensors. According to one embodiment, an aiding system is a three axis magnetometer 201. By sensing the local magnetic field, the magnetometer is able to record the device's two axes of absolute attitude relative to the local magnetic field which can aid correcting drift in other inertial sensors such as the gyroscopes 203. In one embodiment, the magnetometer sensors are off-the-shelf, low noise, solid-state, Gigantic Magneto-Resistance (GMR) magnetometers in small surface-mount packages such as the Honeywell HMC1043. The magnetometers are arranged in three orthogonal axes either on a single multi-axis device, or by using one or more separate sensors in different mounting configurations. According to one embodiment, the output of each magnetometer 203 is an analog signal from two GMR magnetometers arranged in a Wheatstone bridge configuration, which requires a differential operational amplifier 204 to amplify the signal and an anti-aliasing filter 207 to remove high frequency components. These amplified, anti-aliased filters are then sampled by the analog-to-digital (ADC) peripheral inputs of the microprocessor 212. According to one embodiment the anti-aliasing filters are single pole RC low-pass filters that require a high sampling frequency; in another, they are operational amplifiers with multiple-pole low pass filters that may have a slower sampling frequency. According to another embodiment, the output of the gyroscopes is digital, in which case the sensor must be configured for the correct gain and bandwidth and sampled at the appropriate rate to by the microprocessor 212. Unlike conventional MEMS inertial sensors, magnetometer sensors may need considerable support circuitry 208, which in one embodiment include such functions as temperature compensation of the Wheatstone bridge through controlling the bridge current, and low frequency magnetic domain toggling to identify offsets through the use of pulsed set/reset coils. Although not specifically mentioned in the sensor block 200, other aiding sensors could be added. In one embodiment, a Global Positioning System Satellite Receiver is added in order to give absolute geodetic position of the device. In another embodiment, a barometric altimeter is added to give an absolute indication of the vertical altitude of the device. In one more embodiment, beacons consisting of devices using the same wireless transceiver 231 could also tag specific locations by recording the ID of the beacon.

### B. Web-Enabled Clinical Data Management System.

According to one embodiment, as illustrated in FIG. 3, the clinical data management system 309 which contains modules for investigators 301, collaborators 302, clinical subjects 303, and objective devices 310 such as movement monitors and movement systems to log-in, upload data, analyze data, obtain results of automatic analysis, publish results, and collaborate with other investigators. The clinical data management system interface is implemented as an online web application 305. This application is written as a rich client in a programming language such as AJAX or Flex and provides for an application environment that is akin to a fully featured desktop application that can run in any full featured web browser (e.g. Internet Explorer, Firefox, Safari, etc.) and has dynamic content available through the clinical data management system 309. This architecture enables easy use of the system from any Internet enabled location and enhances the scalability and ability to deploy updates to the system.

According to one embodiment, the clinical data management system 309 is implemented using open standards for communication. Communication between the web application 305 and the web clinical data management system 309 happens using the Hypertext Transfer Protocol over Secure Socket Layer (HTTPS) to ensure that communication traffic is encrypted and that the identify of the server can be authenticated. The Extensible Markup Language (XML) is used as the messaging layer, providing for a structured and standardized format for marshaling requests from the web application 305 and responses from the clinical data management system 309.

According to one embodiment, the clinical data management system 309 is implemented using a Model-View-Controller (MVC) web application framework such as Ruby on Rails, Java Struts, or Cake PHP. These frameworks simplify deployment, provide scalability by design, and ease maintenance by enforcing architectural conventions over customization. The clinical data management system 309 complies with robust server design practices including a fully hosted solution with a supporting staff of administrators, automatic backups, RAID, and hosting in a secure location.

The clinical data management system 309 includes modules to enable clinical investigators 301, their collaborators 302, clinical subjects 303, and various objective devices 310 to interface with the system, upload data, analyze data, publish results, share data, and collaborate. Investigators, collaborators, and subjects all log in through the same web application and need to provide a customized username and password to authenticate their identity 306. Each of these users have different uses for the system and are provided with customized views and applications as specified by their user based roles and access privileges 307.

According to one embodiment, the system includes a module to enable investigators to set up and configure multiple, concurrent studies that they are conducting 308. This involves specifying details of their studies such as the start and end dates, sites the study will occur at, a detailed description, the devices being used in the study, and the type of study (i.e., longitudinal, double-blind, etc.). The system also includes a module to enable investigators to specify collaborators 302 who will be able to monitor and help administer the study by adding other users to their study and specifying their role(s) and privileges. Through this process, collaborators may become full peers of the investigator who set up the study, or may have restricted access to comply with study design or other requirements (e.g., double-blinding or HIPAA standards restricting access to protected health information). Additionally, the system includes a module to enable investigators to specify subjects 303 who will participate in the research. This application enables the entry of publicly available information (e.g., an anonymous public ID, height, handedness) as well as protected health information (e.g., birth date, name). According to one embodiment, the system includes a module to enable individual subjects to be used across multiple studies, with unique public identifiers for each one.

According to one embodiment, the system includes a module to enable the data to be uploaded to the system either directly from an objective device 310 or through the web based application 305, 317. According to one embodiment, both of these upload paths require authentication 311, 306 and are performed over an encrypted channel (HTTPS).

According to one embodiment, the system includes a module to support multiple objective devices. Specifically, it includes a module to enable for secure direct data upload and several plugins provided using common programming languages, including C++, Java, and Matlab. Once the data has been received by the server, it is archived in its original, raw format 312. According to one embodiment the system proprietary algorithms 313 are used on data as it is uploaded to perform real-time analysis 314 resulting in derived measures of the data and impairment indices (metrics) 315. The system has the capability of automatic generation for various reports 316 in standard formats such as PDF based on the raw data, and impairment indices generated, available immediately after the upload.

According to one embodiment the system includes a module for storing, visually displaying, processing, and analyzing movement disorder data (e.g. inertial data, clinical annotations) automatically uploaded from objective devices. Specifically, it incorporates a module for time-domain signal representation, time-domain analysis, statistical analysis, biostatistical analysis, automatic event-detection, correlation analysis, automatic diagnosis, frequency-domain representation, frequency-domain analysis, parametric and nonparametric power spectral density estimation (PSD), statistical modeling, statistical processing, adaptive filtering for noise elimination, artifact elimination, signal feature enhancement, nonlinear analysis, complexity analysis, state-space methods for parameter estimation such as Kalman filters and particle filters, and clinical annotations.

According to one embodiment, the system includes a module to enable investigators to have access to an application for managing the data associated with a particular study 317. In addition to an interface enabling the uploading of raw data, this application provides an interface for assigning metadata to the uploads that may be critical to the analysis and interpretation of the data in the context of the study. This metadata may include the originating subject, the experimental conditions under which the data was collected, lab notes, etc. The data management application also provides mechanisms for grouping related data together to match criteria specified in the design of the study 308. One such grouping includes data originating from a single subject across time for longitudinal studies. Another grouping includes data originating from a single subject from different devices and clinical scoring sessions for the purpose of correlation studies.

According to one embodiment, upon completion of each upload, automated reports in PDF format are made available to investigators, collaborators, and subjects 316 based on signal processing algorithms running on the server. One such report provides instant feedback as to the validity of the collected data. The system includes digital signal processing, statistical signal processing, biomedical signal processing, statistics, nonlinear analysis and pattern recognition algorithms in order to identify anomalous data including artifacts, outliers, and invalid values. These reports can be used for immediate assessment of data collection practices and to ensure that hardware is working as specified. According to one embodiment, the system automatically generates suggestions in the reports for possible remediation of encountered issues based on the signal processing analysis. Another report provides an assessment of the uploaded device data in the form of an objective motor score which can be used to compare the results to those obtained from other objective devices supported by the system or clinical rating scores such as the UPDRS. In other embodiments, the automatic reports are generated using other standard formats in addition to PDF and each component of the report is available independently including results figures, results tables, descriptive statistics, inferential statistics, individualized results, population results, and interpretation narrative.

According to one embodiment, the system includes a module to produce reports to enable investigators to track the progression of motor dysfunction in subjects over the course of a clinical trial. The system includes a module to enable individual subjects to examining trends in their own performance and compare their scores to others in a similar state. In addition to single subject reports, the system includes a module for generation of population reports in order to view the pooled response throughout a study across all participating subjects.

According to one embodiment, the clinical data management system 309 includes the a module to provide continuous updates on the progress of clinical trials and display the progress of different treatment arms. This is completed automatically without breaking the blinding of groups, data analysts, investigators, collaborators, or sponsors.

According to one embodiment the results can be displayed with an interactive graphic. When data points are clicked on the graphic, other more detailed graphics about that data point or an automatic report may be provided.

According to one embodiment, the system is designed to prevent researchers from disclosing information about their subjects that could be used to identify them. In this embodiment, the system includes a module for HIPAA enforcement through role based and individualized privileges that are assigned by the study administrator. These roles and privileges are scoped for each study, so that a user with access to PHI in one study, for example, may not have these privileges in another.

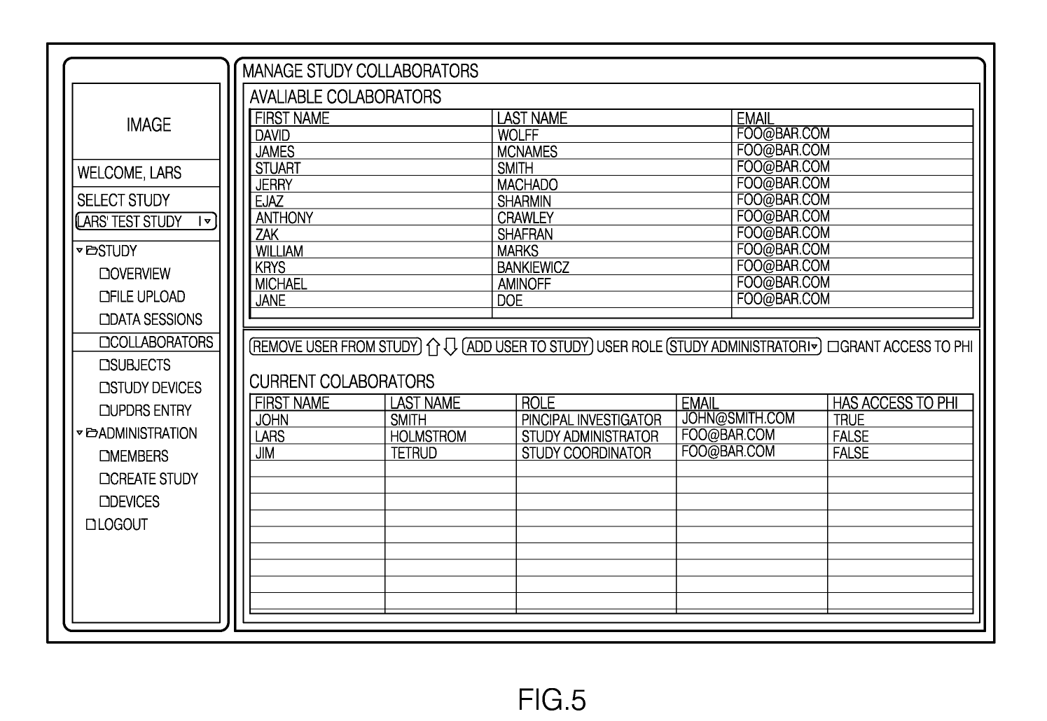

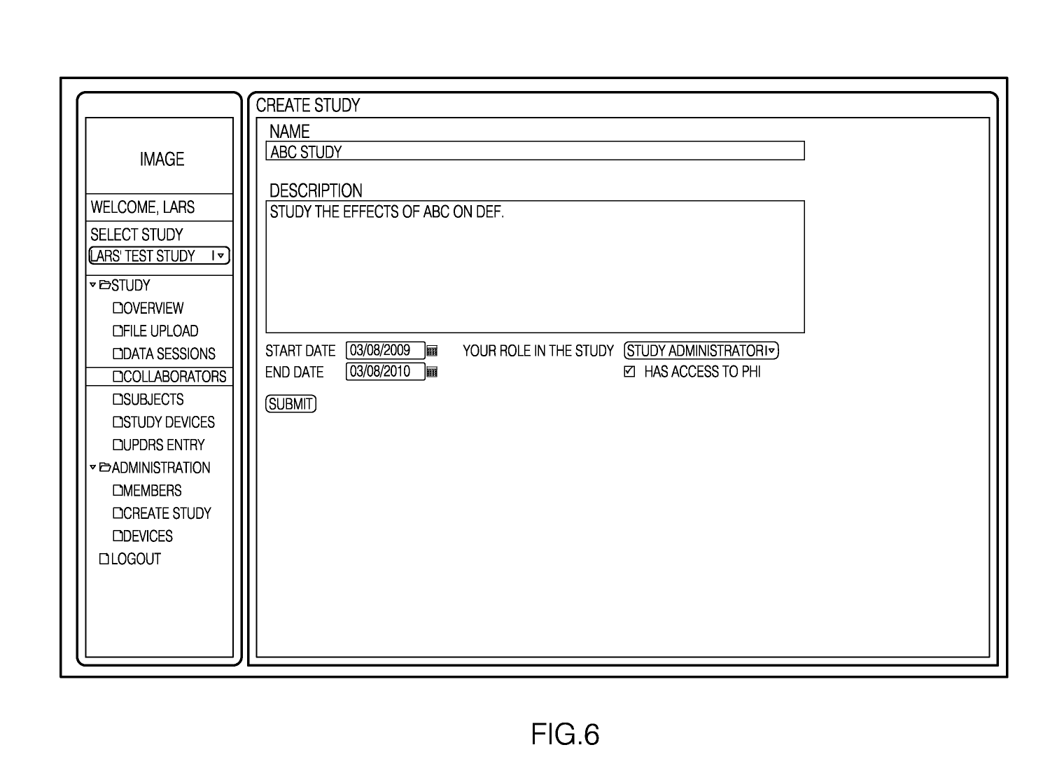

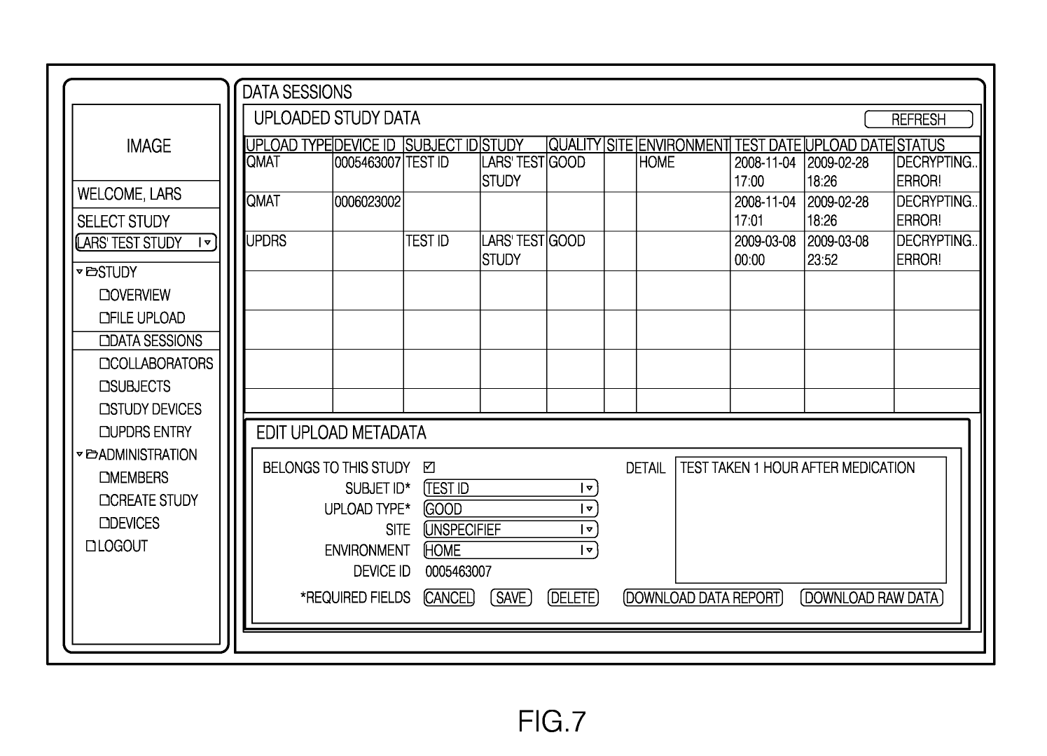

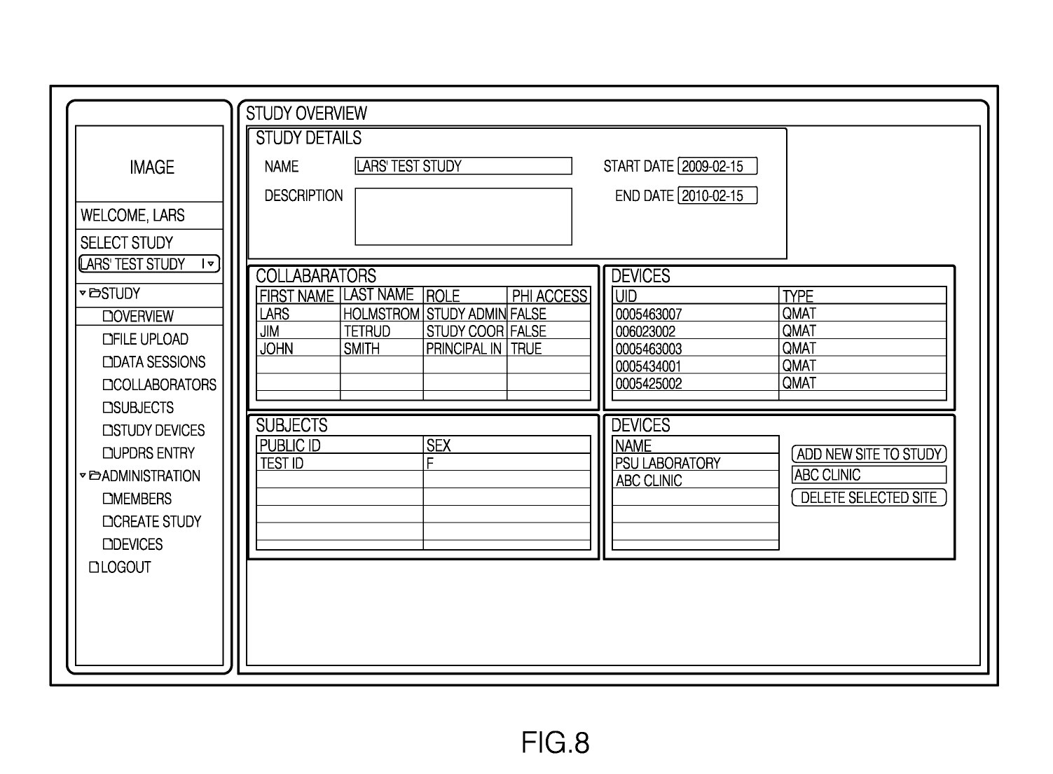

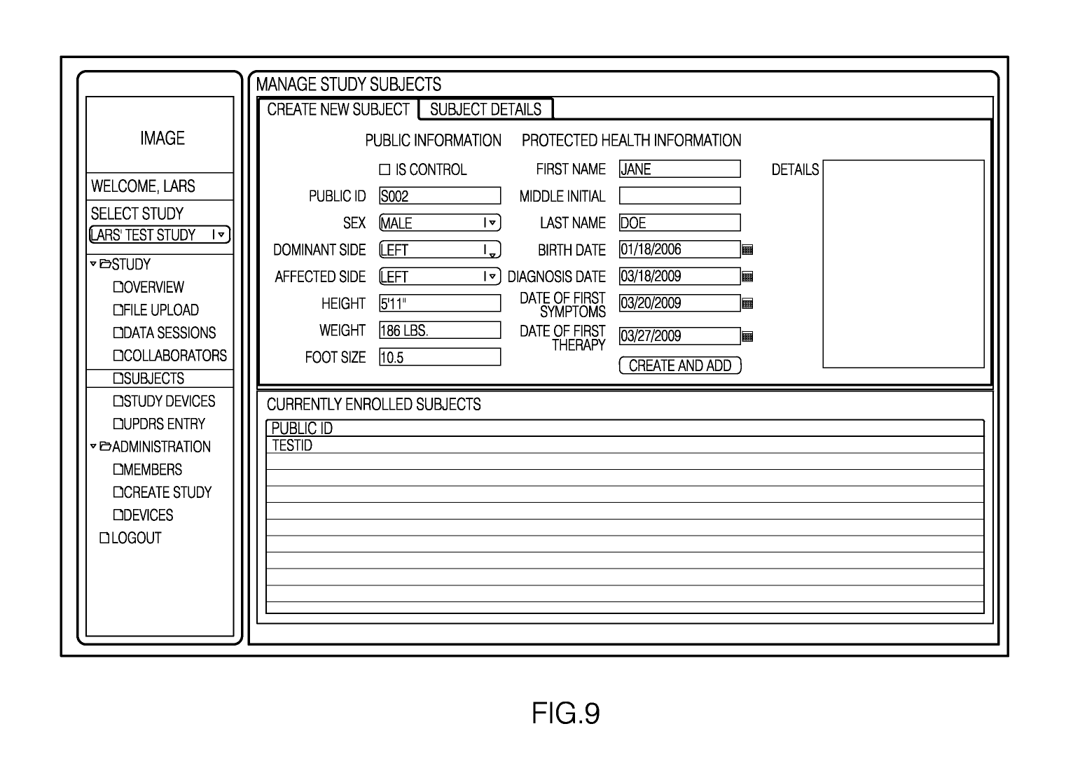

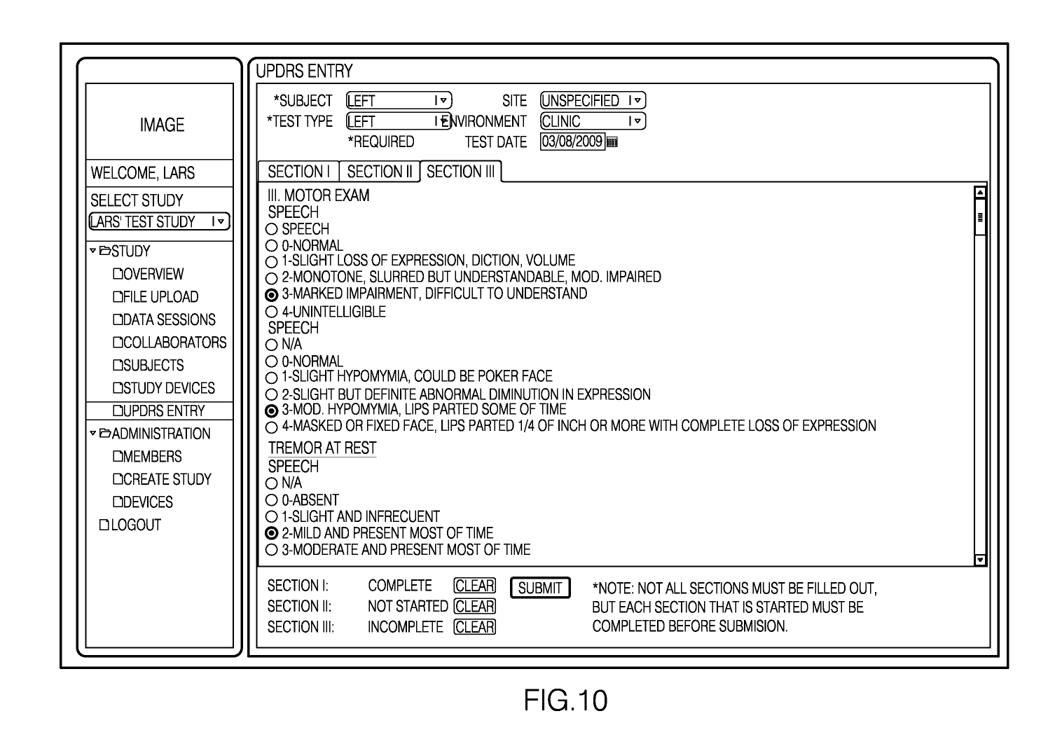

According to one embodiment, the graphical user interfaces and functionality of the system resemble the GUIs shown in FIG. 4 to FIG. 10. FIG. 4 illustrates an embodiment of the GUI for uploading device data through the web based application. FIG. 5 illustrates an embodiment of the GUI for adding collaborators to the current study. The collaborator's role can be specified along with whether they have permissions to view protected health information (PHI) in the specified study. Users can have different roles and permissions for different studies. FIG. 6 illustrates an embodiment of the GUI for creating a new study. FIG. 7 illustrates an embodiment of the GUI for data management application. It provides an interface for assigning metadata to uploaded data, such as the ID of the originating subject, the environment the test was taken in, and additional notes. Uploaded data that does not have the minimum amount of metadata assigned to be useful for analysis is highlighted. The status of each upload (right column, top panel) provides information about whether the data was uploaded correctly and could be decrypted. Both the raw data and an analysis report covering the upload can be downloaded (two buttons on the bottom right). FIG. 8 illustrates an embodiment of the GUI for the study overview application. This application provides relevant details about the selected study in a compact form, including a list of collaborators and their permissions, the IDs of devices being used in the study, subjects that are enrolled for the study, and sites at which the study is being performed. FIG. 9 illustrates an embodiment of the GUI for the subject enrollment application. This allows the study administrator to add subjects to the system after entering their public and protected health information and any relevant details about the subject. Users can specify custom fields for use in their study. FIG. 10 illustrates an embodiment of the GUI where clinical rating scores, such as the UPDRS, can also be entered through the system.

According to one embodiment, the GUI of the web application is especially adapted to be used in combination with smart-phones or PDA including those with touch technology. This includes the ability to upload the raw data directly from the smart-phone, managing it, analyzing it, sharing it, and receiving automatic reports directly on the smart-phone devices. The web application automatically detects the type of device accessing it (e.g. computer, smart-phone, web-enabled phone, smart-phone with touch technology such as the iPhone) and changes automatically in order to optimize the user experience accordingly. According to one embodiment, the web application takes the form of a local phone application which interfaces with the server. This results in increased speed and improved user experience because the interface graphics and animations do not have to be downloaded over the Internet, only the actual data and the results of the queries.

According to one embodiment, the clinical data management system 309 includes a module to enable portable devices including cellular phones, portable games, and personal digital assistants, to be used to directly upload patient reported outcomes, activities, events, and times of medications. Activities may include exercise, meals, and naps. Events may include falls, near-falls, and postural transitions such as sit-to-stand and stand-to-sit.

According to one embodiment, when wearable devices are used to monitor impairment, they may communicate directly with portable devices to upload data. Portable devices with Internet access may then be used to download information or analysis of recent device data and provide nearly real-time monitoring results.

According to one embodiment, different types of data collected during the same assessment period can be grouped and treated as a whole unit on the clinical data management system 309. This may include one or more rating scales and one or more sessions of objective device data.

According to one embodiment, the clinical data management system 309 implementation is especially designed to enable to be licensed for deployment at different sites. A plugin architecture and published abstract programming interface (API) enables other licensees of the system to add support for other devices. This includes, but is not limited to, capturing data from these devices, analyzing these data, generating automated reports of these data, and disseminating these data to interested and privileged parties. The plugin architecture is designed to support analysis and report generation code from a number of different programming languages/environments including but not limited to Matlab, Java, C++, and Ruby.

According to one embodiment, the clinical data management system 309 is designed to support the sharing of data between different systems that capture and manage personal health information. According to one embodiment, the clinical data management system 309 includes a module to exchange personal health record information with online systems such as Google Health, Microsoft HealthVault, and WebMD Health Manger. Personal health information that may be vital to the analysis and interpretation of data collected by objective motor devices can automatically be imported into the clinical data management system 309, minimizing data entry and providing for automatic updates to this data when personal health information is modified by patients or their physicians. Results of the analysis performed by then clinical data management system 309 can be pushed to these online systems, allowing patients and their physicians to track the progression of movement disorders and make informed decisions about therapies and interventions.

The clinical data management system 309 includes a module to support the sharing of data with other systems that manage data related to movement disorders. According to one embodiment, the clinical data management system 309 specifies an Extensible Markup Language (XML) schema defining the export format of data managed by the server. A plugin architecture enables external researchers or institutions to specify an Extensible Stylesheet Language Transformation (XSLT) which transforms the native schema into an external one and visa versa. This functionality allows for the seamless integration of systems using disparate internal representations of data. An XML schema is also specified which defines an XML protocol for requesting data from the server and pushing data to the server. This schema provides for the specification of credentials for authentication, the scope of the data being requested, and the XSLT to use to convert between native and external data formats. According to one embodiment the clinical data management system 309 interacts with the server to store the data locally, and synchronize information (upload and download) when they are able to obtain Internet access.

### C. Automatic Analysis and Processing Algorithms.

According to one embodiment, the clinical data management system 309 includes digital signal processing and analysis methods (algorithms) 106 to process the raw device data and extract the metrics of interest. According to one embodiment these methods are insensitive to normal voluntary activities, but provide sensitive measures of the motor impairments of interest. These metrics include tremor, gait, balance, dyskinesia, bradykinesia, rigidity, and overall motor state. The computer implemented methods 106 employ digital signal processing and statistical signal processing techniques to analyze the raw data and create movement disorder metrics. These techniques include FIR and IIR filters, FFT-based spectrum analysis, re-sampling, nonparametric power spectral density estimation techniques such as Welch's and Blackman-Tukey's methods, parametric power spectral estimation techniques based on AR, MA, and ARMA models, optimum Wierner filtering, statistical modeling, state-space methods and estimation algorithms such as Kalman filters, Extended Kalman filters, particle filters and Monte-Carlo methods, nonstationary spectral analysis techniques such as the short-time Fourier transform, nonlinear analysis techniques including approximate entropy, sample entropy, Lempel-Ziv complexity, and multiscale entropy, template matching filters, and even-detection algorithms.

While particular embodiments have been described, it is understood that, after learning the teachings contained in this disclosure, modifications and generalizations will be apparent to those skilled in the art without departing from the spirit of the disclosed embodiments. It is noted that the foregoing examples have been provided merely for the purpose of explanation and are in no way to be construed as limiting. While the system has been described with reference to various embodiments, it is understood that the words which have been used herein are words of description and illustration, rather than words of limitations. Further, although the system has been described herein with reference to particular means, materials and embodiments, the actual embodiments are not intended to be limited to the particulars disclosed herein; rather, the system extends to all functionally equivalent structures, methods and uses, such as are within the scope of the appended claims. Those skilled in the art, having the benefit of the teachings of this specification, may effect numerous modifications thereto and changes may be made without departing from the scope and spirit of the disclosed embodiments in its aspects.

The invention claimed is:

1. A system for managing clinical data, said system comprising:
(a) a server configured to receive data from one or more external devices, and
(b) a clinical data management application comprising one module for storing raw movement data received from at least one of said devices.

2. The system of claim 1, wherein said clinical data management application further includes a module to enable said raw movement data to be received directly from an external device such as a movement monitor capable of collecting accelerometer data, gyroscope data, and magnetometer data.

3. The system of claim 2, wherein said clinical data management application further includes a module for analyzing said raw movement data using a plurality of computer-implemented statistical analysis methods.

4. The system of claim 3, wherein said computer-implemented statistical analysis methods comprise one or more digital signal processing and statistical signal processing techniques to process and analyze said raw movement data.

5. The system of claim 4, wherein said clinical data management application further includes a module for visualizing results of said module for analyzing said raw movement data and generating one or more automatic analysis reports.

6. The system of claim 5, wherein said clinical data management application further includes a module to enable investigators, collaborators, and subjects to share data and obtain said automatic analysis reports based on a set of access privileges.

7. The system of claim 6, wherein said clinical data management application is implemented as an online web application.

8. The system of claim 7, wherein said clinical data management application further includes a module to generate reports to track the progression of motor dysfunction over a specified period of time.

9. The system of claim 8, wherein said clinical data management application further includes a module to support bidirectional data sharing with other clinical data management and personal health information systems.

10. The system of claim 9, wherein said clinical data management application further includes a module to automatically detect a client device and select a especially adapted graphical user interface for said client device.
